(19) United States
(12) Patent Application Publication
(10) Pub. No.: US 2008/0189121 A1
(43) Pub. Date: Aug. 7, 2008

(54) Home owner's association (HOA) summary & comparison reports

(76) Inventor: Jai Brooks, Superior, CO (US)

Correspondence Address: Jai Brooks;The Hoa Expert, P.O. Box 270667, Louisville, CO, 80027, US

(21) Appl. No.: 11/538,617

(22) Filed: Feb. 5, 2007

(51) Int. Cl. G06Q 10/00; G06F 7/00

(52) U.S. Cl. 705/1; 707/1

(57) ABSTRACT

Real estate related software that aggregates data from home owner's associations for residential properties. It reports the data in a summarized one page report online. Simply enter an address and you can review—Hoa fees, locate how many hoas' are within a subdivision, assessment information, inclusions, amenities, summary of guidelines, FHA approved project status, taxes, owner occupancy information, number of lots, insurance provider, and management company contact information. You can email, fax, or save the reports.

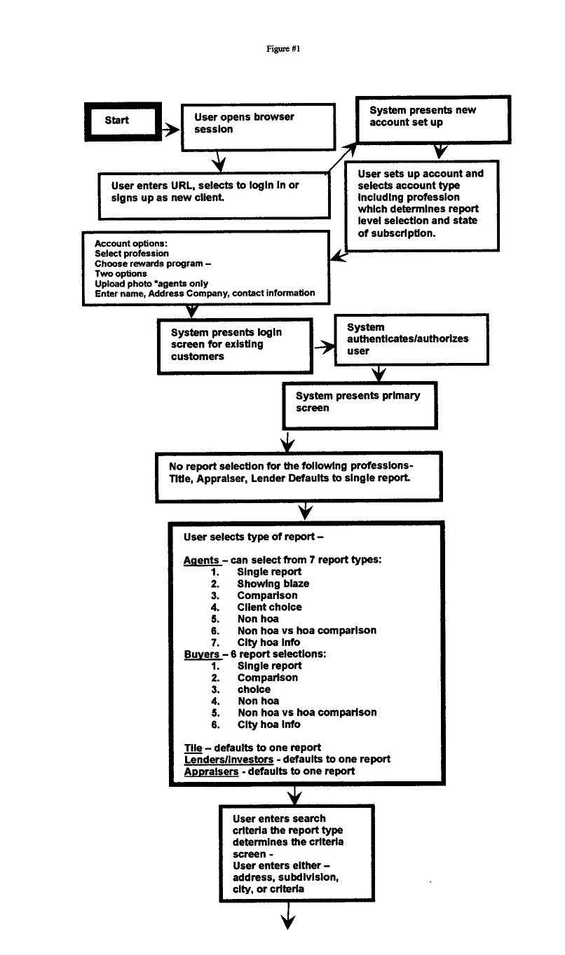

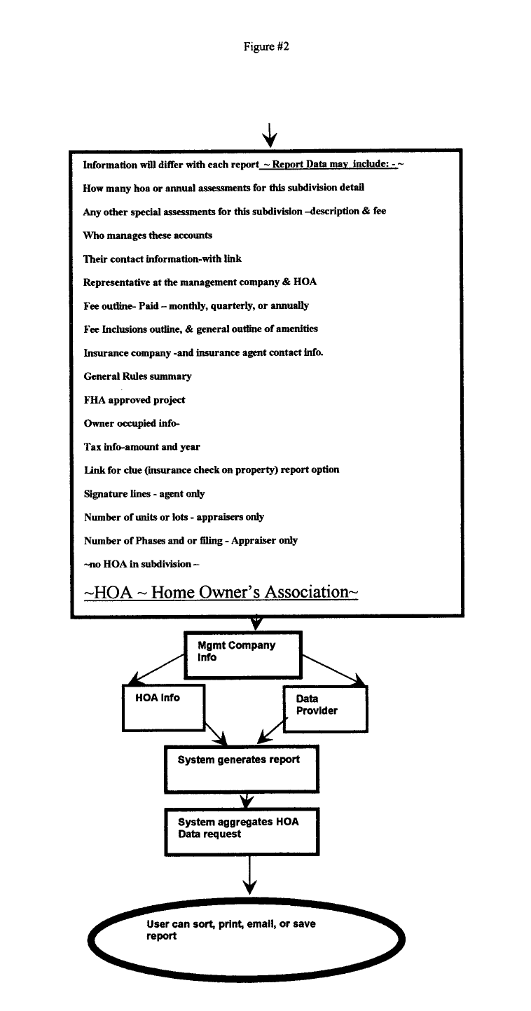

Real estate computer software aggregates HOA data based on a user entering—an address, or city, or subdivision, or project name, or specific criteria. The software will generate a report or multiple reports to compare selected HOA and subdivision information. In addition, software will outline hoa information for any subdivision. In a report format, you can sort, print, email, and save these reports. Clients are charged a fee for the service.

### Reports—(11 Reports Total)

Non-hoa areas vs. hoa areas—by selection of city or county.
Client choice reports—user will enter client's needs and our report will generate a list of matched HOA/subdivisions meeting selected criteria.
Showing Blaze—allows agents to select several subdivision and compare.
Reports by city comparison.
Report—If no HOA in subdivision—
Hoa comparison—select up to 4 subdivision to compare
Single Property Search.
Appraiser reports-single search.
Lender reports-single search.
Title reports-single search.
Subdivisions in a city and the Management Companies who manage the acct.
Reports will be in color and have logo info, signature lines. Reports can be emailed, printed, saved, and sorted prior to printing or saving.

### Report Data will include

How many hoa or annual assessments for this subdivision—detail
Any other special assessments for this subdivision—description & fee
Who manages these accounts—
Their contact information-with link
Representative at the management company & HOA
Fee outline—Paid—monthly, quarterly, or annually
Fee Inclusions outline, & general outline of amenities
Insurance company—and insurance agent contact info.
General Rules summary
FHA approved project
Owner occupied info—
Tax info-amount and year
Link for clue (insurance check on property)report option
Signature lines—agent only
Number of units or lots—appraisers only
Number of Phases and or filing—Appraiser only Information will differ with each report selection

### Client Base

Agents
Appraisers
Lender/Investors
Buyers
Title companies
General public

Process Overview TheHOAExpert.com is intended to provide Real Estate Professionals browser based aggregation and reporting of HOA Information, subdivision hoa guidelines summary, tax information, multiple hoa information, summary of amenities, owner occupied information, FHA approved information, non-hoa subdivisions, phases & filings, total units, and insurance information in a report format.

The HOAExpert.com will bring together HOA information from a 3_{rd} party data provider and information developed by TheHOAExpert.com to provide accurate associations of HOA(s) information to subdivisions and residential properties. This is a very simple and straight forward business problem. Initial focus will be on this primary use case, licensing individual and corporate users/groups for the basic service using a simple online ecommerce based model. This licensing would grant the user access to the online reporting capabilities provided by TheHOAExpert.com.

Future enhancements may result in an advanced user experience, and an additional set of entitled services. The business model described in this functional specification does not vary by geographic locale, but remains static.

Software/Hardware Environment Considerations the objective is a simple to use, browser based user experience with good performance characteristics for users with a standard high-speed internet connection (DSL as an example). We want to ensure that users do not encounter unnecessary technical difficulties such as those related to old browsers or browsers with Javascript property settings turned off. This emphasizes the importance of following a conservative course regarding compatibility with commonly-used web browsers. As such, it is assumed that HOAExpert will deliver XML pages to users. It is assumed that the user's browser can support the features used on HOAExpert.com. Browser side Java (applets) will not be used or supported (same holds true if the .net framework is leveraged as the design framework—I am using J2EE in this example). Javascript will be used on a limited basis to enhance functionality, however, the application will be written so that users without Javascript functionality are presented with all information regardless of whether they have Javascript processing available.

Users without Javascript processing will be unaware of any ‘missing’ functionality. This design strategy provides for ‘graceful degradation’. Initial user ramp-up is predicted to be 3500 new users/month for the first 6 months, ramping up to 1500 new users/month thereafter. Concurrent usage is difficult to predict, but will need to be estimated. Noting the geographic nature of this solution, it is entirely acceptable to partition either logically or physically as deemed appropriate to support good performance by geographic location, although minimizing the operational costs associated with the production environment(s) would be desired. Please note the need to routinely transact data requests with the 3_{rd} party provider of HOA information. The nature of this service, its API, and its through put capacity is unknown at this time and requires investigation.

There is nothing particularly sensitive about the information being accessed and reported upon within the primary use cases identified to date. However, any user information exchange, such as in eCommerce transactions and/or user information management/persistence, is certainly expected to be securely transported and encrypted. Data persistence should be secure from unauthorized access/attack. It might be the case that in the future TheHOAExpert.com would be released to an open source community. As such, this should be taken into account in the design (regardless if that is a net or J2EE framework).

HOA information is available from internal persistence and data services to the HOAExpert for aggregation and reporting within the HOAExpert application. User is able to enter the Address, subdivision name, city, or client needs of a perspective piece of real estate or several locations, and receive all relevant HOA Information in a report format.

Use Case for Property to HOA Information Report

3 System presents the user login screen
4 User enters his/her username and password
5 System authenticates the user login, and authorizes the user based upon his/her license
6 User sets up a new account if needed—selects profession and home state.
7 System presents the user the primary user interface (UI) screen
8 User selects the type of report to generate—HOA Information Report (HOA-IR)
9 System presents the HOA Information query screen
10 User enters the Address, or subdivision, or city, or client's needs
11 System references the HOA information persisted for the user request
12 System aggregates the HOA Information Report. Reportable attributes are:
HOA associated with the Address of Residence entered
How many hoa or annual assessments for this subdivision—detail
Any other special assessments for this subdivision—description & fee
Who manages the account—
Their contact information-with link
Representative at the management company & HOA
Fee outline—Paid—monthly, quarterly, or annually
Fee Inclusions outline, & general outline of amenities
Insurance company—and insurance agent contact info.
General Rules summary
FHA approved project
Owner occupied info—
Tax info-amount and year
Signature lines—agent only
Number of units or lots—appraisers only
Number of Phases and or filing—Appraiser only
Information will differ with each report
If no HOA in subdivision—a letter of confirmation will be available to print
   13 System returns the report to the user, and presents it in the report screen
   14 User can sort, print, or email the report, or downloads a secure format softcopy (client side)
   15 User returns to the primary screen
   16 User selects to logout
   17 System prompts the user to confirm they intend to logout
   18 User confirms their intent to log out
   19 System terminates user's session

### BACKGROUND OF THE INVENTION

Currently real estate professionals or potential buyers have to identify, locate, and acquire contact information for home owner's associations. The guidelines are not readily available to the general public or to real estate professionals. The process of calling title companies, hoa volunteers and potential management companies is tedious and unreliable. Real estate professionals know this is a time consuming process, but necessary for completing a contract, verifying inclusions, and checking fees. The management company does not generally list over the phone every inclusion or fee. So, if you don't ask the right questions the information is generally not given. You can purchase these documents for a various fees from $50-$100. Only if you able to find who manages the subdivision, it's not public knowledge. In addition, the documents are usually 50+ pages. For this reason I decided to create a solution for Real estate professionals and the general public. My software summarizes the hoa documents and converts the valuable data into an easy to read one page report.

### BRIEF SUMMARY OF INVENTION

The software allows users to enter an address of a property and instantly obtain subdivision information & HOA information. This a web based program offering comparison reports, summary reports, and a general outline of all fees, inclusions, contact information for management companies, assessment information, tax information, owner occupied data, FHA approval status, general rules and guidelines, verification of single or multiple hoa fees.

### DETAILED DESCRIPTION

The software allows users to enter an address of a property and instantly obtain subdivision information & HOA information. This a web based program offering comparison reports, summary reports, and a general outline of all fees, inclusions, contact information for management companies, assessment information, tax information, owner occupied data, FHA approval status, general rules and guidelines, verification of single or multiple hoa fees. A user will start by opening their browser and entering the URL (www.hoaexpert.com). The program will request user name and password. If they are an existing customer they login, if not, they setup a new account and then log in. The new account setup will ask the user to select their profession or buyer status and state to track hoa information. The software will auto select the report types for all professions except real estate agents and buyers. These two categories have additional report options. All other professions default to one report search.

They are then prompted to enter search criteria depending on the report type—address, city, subdivision, or criteria. The program retrieves the data from our information providers and our data base, which generates a report. The user can sort fields of the report prior to printing, otherwise they can print, save, or email the report. There currently to my knowledge is not another program reporting this information in this summarized report format.

1. Computer Software that aggregates HOA (home owner's association) reports. For Real estate agents, buyers, title companies, lenders, investors, and appraisers. These reports give a summary of Hoa information for residential properties. The reports can include some or all of the following information depending on report type selection—
Name of HOA, HOA's associated with the Address or subdivision/project. How many hoa's or annual assessments for this subdivision, hoa fees outline-paid—monthly, quarterly, or annually, fee Inclusions outline, any other special assessment fees for this subdivision, who manages these accounts, the contact information-with link to management company and hoa representative, general outline of amenities, insurance company for hoa—and insurance agent contact info, general rules summary, FHA approved project, owner occupied info, tax amount and year, number of units, number of lots in subdivision, number of Phases and filings, and no hoa in subdivision info.
